(19) United States
(12) Patent Application Publication
(10) Pub. No.: US 2013/0195383 A1
(43) Pub. Date: Aug. 1, 2013

(54) TARP THAT FOLDS AND CLOSES FOR TRANSPORTING ITEMS

(71) Applicant: Michael Craig Daugs, JR., Hayes, VA (US)

(72) Inventor: Michael Craig Daugs, JR., Hayes, VA (US)

(21) Appl. No.: 13/731,082

(22) Filed: Dec. 30, 2012

Related U.S. Application Data
(60) Provisional application No. 61/593,201, filed on Jan. 31, 2012.

(51) Int. Cl. B65D 51/00

(52) U.S. Cl. CPC B65D 51/00
USPC 383/12

(57) ABSTRACT

A closable tarp allows a user to put household items, such as grass clippings, leaves, clothes and the like, on the tarp. The user can fold the tarp in half and close it to create an interior storage and transportation section. Handles can be provided to allow for easy transportation of the closed tarp. The closable tarp of the present invention is easy to clean and completely reusable.

### CROSS-REFERENCE TO RELATED APPLICATION

This application claims the benefit of priority of U.S. provisional application No. 61/593,201, filed Jan. 31, 2012, the contents of which are herein incorporated by reference.

### BACKGROUND OF THE INVENTION

The present invention relates to tarps and, more particularly, to a tarp that folds and closes to allow for easy transportation of items.

Household bags, such as household trash bags, are messy, expensive and can fill up quickly. While there are bags designed for lawn debris, such as grass clippings and leaves, it can be difficult to pick up the items and place them into the bag. Moreover, conventional household bags are usually made of plastic which can be an environmental concern. While tall paper bags are available, they can be difficult to reuse if someone desires only moving leaves or grass clippings, for example, from their yard to a compost area, as when these paper bags get wet, they can fail.

Conventional tarps cover over the top of items, or allow items placed on top of the tarps to be dragged. However, when dragging the items, some things can fall off the tarp or get blown away, for example.

As can be seen, there is a need for a device that allows easy placement of items, such as grass clippings, leaves and the like and can close around the items to prevent loss thereof.

### SUMMARY OF THE INVENTION

In one aspect of the present invention, a closable tarp comprises a tarp body; a zipper disposed along an outer periphery of the tarp body, the zipper operable to close the tarp when the tarp is folded onto itself along a mid-line thereof; and one or more handles disposed along the outer periphery of the tarp body.

In another aspect of the present invention, a closable tarp comprises a tarp body; a zipper disposed along an outer periphery of the tarp body, the zipper operable to close the tarp when the tarp is folded onto itself along a mid-line thereof; corner handles disposed on each corner of the tarp body; fold line handles disposed on opposite sides of the tarp body; and grommets disposed along the outer periphery of the tarp body.

These and other features, aspects and advantages of the present invention will become better understood with reference to the following drawings, description and claims.

### BRIEF DESCRIPTION OF THE DRAWINGS

FIG. 1 is a detailed perspective view of a closable tarp according to an exemplary embodiment of the present invention;

FIG. 2 is a perspective view of the closable tarp of FIG. 1, being carried by a user;

FIG. 3 is a perspective view of the closable tarp of FIG. 1;

FIG. 4 is a perspective view of the closable tarp of FIG. 1 in a partially closed configuration;

FIG. 5 is a perspective view of the closable tarp of FIG. 1 showing opening and closing of the tarp;

FIG. 6 is a perspective view of the closable tarp of FIG. 1 in an open configuration; and

FIG. 7 is a cross-sectional view taken along line 7-7 of FIG. 3.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a closable tarp that allows a user to put household items, such as grass clippings, leaves, clothes and the like, on the tarp. The user can fold the tarp in half and close it to create an interior storage and transportation section. Handles can be provided to allow for easy transportation of the closed tarp. The closable tarp of the present invention is easy to clean and completely reusable.

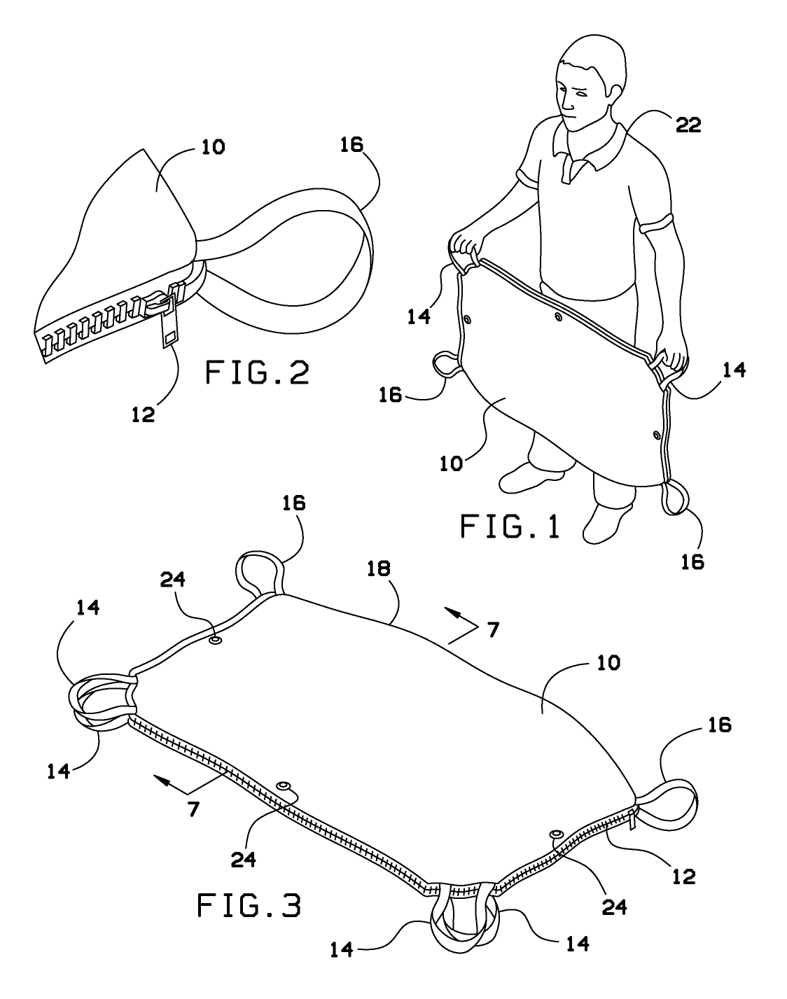

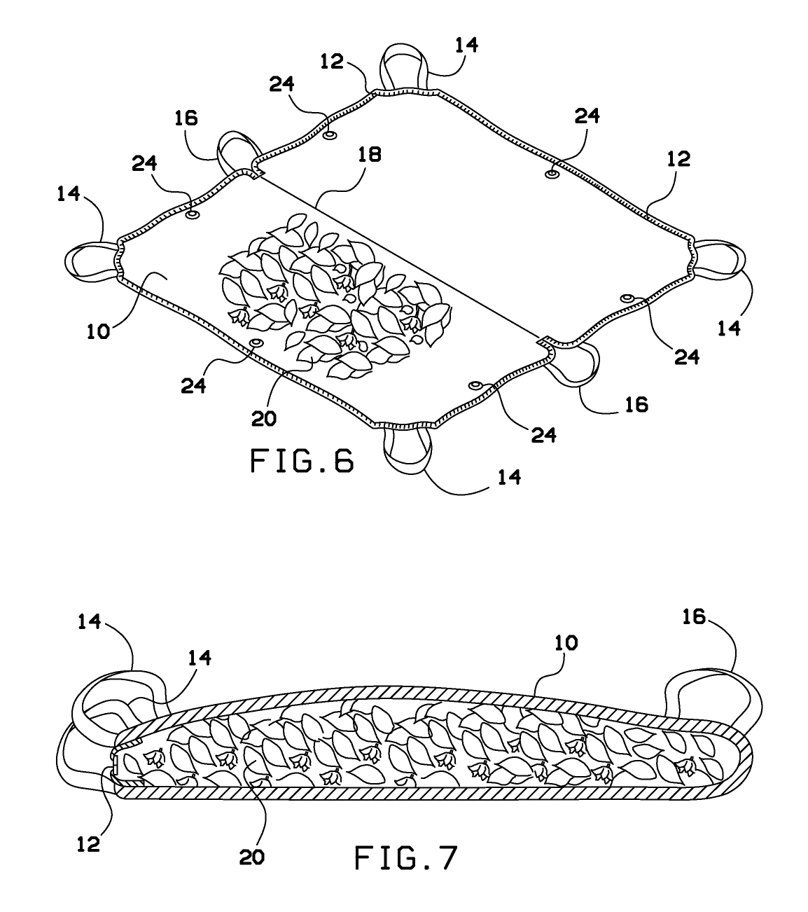

Referring now to FIGS. 1 through 7, a closable tarp 10 can be designed to lay flat on a surface to allow a user 22 to place items 20 on top of the tarp 10 as shown in FIG. 6. Typically, items 20 are placed on one side of the top of the tarp 10, but, if the user does place items 20 on both sides, these items can be moved to one side as the tarp is folded in half as shown in FIG. 5.

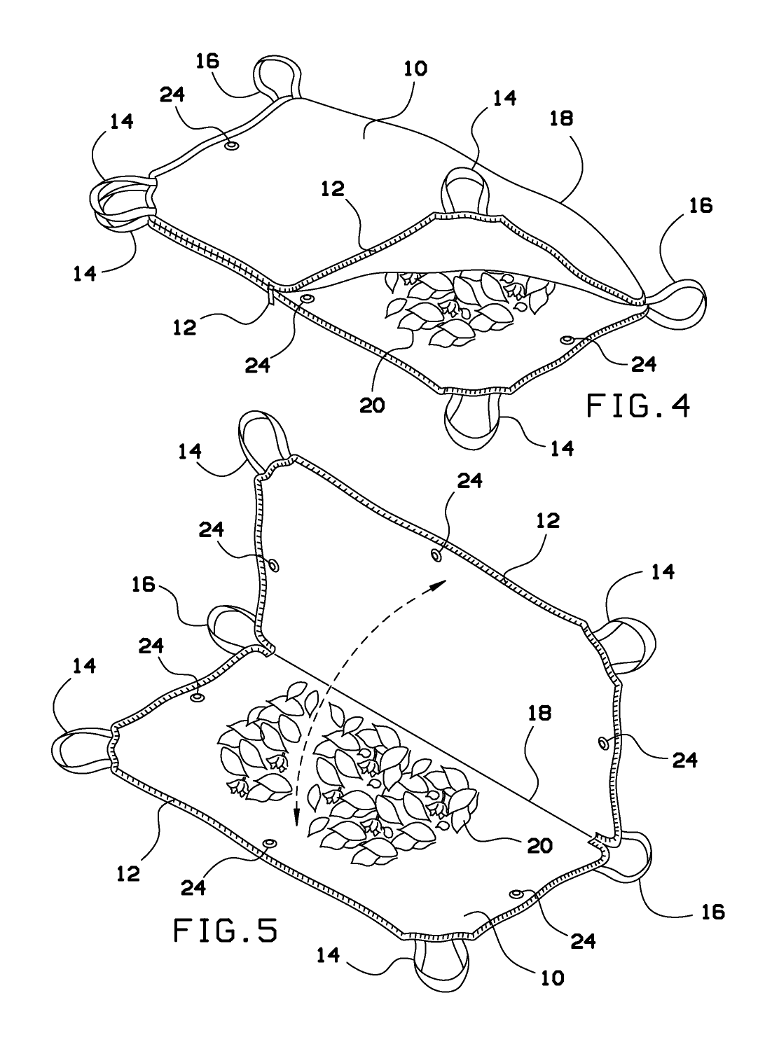

The tarp 10 can include a zipper 12 disposed about an outer periphery of the tarp 10. The zipper 12 can be designed to close the tarp 10 when folded in half as shown in FIGS. 3 and 4, for example.

One or more handles can be disposed on the tarp 10. Typically, corner handles 14 can be disposed at each of the four corners of the tarp 10. Fold line handles 16 can be disposed along opposite sides of the tarp 10 along a location where the tarp 10 is folded in half when closed. Typically, the fold line handles 16 attach on each side of a mid-line 18 of the tarp 10.

Grommets 24 can be disposed at or near an outer periphery of the tarp 10. The grommets 24 can be useful to, for example, attach a rope to pull the tarp 10, if needed. The grommets 24 can be disposed such that a grommet on one half of the tarp aligns with a grommet on the other half of the tarp when the tarp is folded along the mid-line 18 thereof.

The tarp can be made from various materials. Typically, for outdoor use (such as for leaves, lawn clippings or the like), the tarp can be made of a reinforced plastic material. In some embodiments, the tarp may be made of fabric or some other flexible material. In some embodiments, the tarp can include a liner disposed on the inside thereof. The liner can help insulate the tarp if needed for a desired application. The handles can be made of the same or a different material. For example, the handles can be made of plastic, fabric, or the like.

The tarp can be made in various sizes. For outdoor use, for example, the tarp can be square or rectangular with dimensions from about 4 feet to about 30 feet on each side.

It should be understood, of course, that the foregoing relates to exemplary embodiments of the invention and that modifications may be made without departing from the spirit and scope of the invention as set forth in the following claims.

What is claimed is:

1. A closable tarp comprising:
a tarp body;
a zipper disposed along an outer periphery of the tarp body, the zipper operable to close the tarp when the tarp is folded onto itself along a mid-line thereof; and
one or more handles disposed along the outer periphery of the tarp body.

2. The closable tarp of claim 1, further comprising corner handles disposed on each corner of the tarp body.

3. The closable tarp of claim 1, further comprising fold line handles disposed on opposite sides of the tarp body.

4. The closable tarp of claim 3, wherein the fold line handles have ends that attach to opposite sides of the mid-line of the tarp body.

5. The closable tarp of claim 1, further comprising grommets disposed along the outer periphery of the tarp body.

6. The closable tarp of claim 5, wherein pairs of grommets align with each other with the tarp body is folded.

7. The closable tarp of claim 1, wherein the tarp body lies flat on a surface when the zipper is unzipped.

8. A closable tarp comprising:
a tarp body;
a zipper disposed along an outer periphery of the tarp body, the zipper operable to close the tarp when the tarp is folded onto itself along a mid-line thereof;
corner handles disposed on each corner of the tarp body;
fold line handles disposed on opposite sides of the tarp body; and
grommets disposed along the outer periphery of the tarp body.

9. The closable tarp of claim 8, wherein the fold line handles have ends that attach to opposite sides of the mid-line of the tarp body.

10. The closable tarp of claim 8, wherein the tarp body lies flat on a surface when the zipper is unzipped.
